(19) United States
(12) Patent Application Publication
(10) Pub. No.: US 2008/0071831 A1
(43) Pub. Date: Mar. 20, 2008

(54) CREATING ANIMATION BASED ON A KEYWORD SEARCH

(76) Inventor: Venkateshwara N. Reddy, Cupertino, CA (US)

Correspondence Address: Hahn & Moodley, P.O. Box 52050, Minneapolis, MN, 55402, US

(21) Appl. No.: 11/532,071

(22) Filed: Sep. 14, 2006

(51) Int. Cl. G06F 17/00

(52) U.S. Cl. 707/104.1

(57) ABSTRACT

In one aspect, the invention provides a method for creating animation. The method comprises generating an exemplary animation file for each of a plurality of animation effects; associating at least one keyword with each exemplary animation file; receiving a search string from a user, the search string being indicative of an animation effect of interest; performing a search to identify each animation effect for which there is a match between the search string and the at least one keyword associated with the animation effect; providing information about each animation effect identified in the search to the user, receiving user-input to select an animation effect identified in the search; and responsive to the user-input to identify the animation effect, binding the animation effect to a selected object.

### FIELD OF THE INVENTION

Embodiments of the invention relate to creating animation.

### BACKGROUND

Flash is a popular authoring software developed by Macromedia, to create vector graphics-based animation programs with full-screen navigation interfaces, graphic illustrations, and simple interactivity in a resizable file format that is small enough to stream across a modem connection. The software is ubiquitous on the Web, both because of its speed (vector-based animations, which can adapt to different display sizes and resolutions, and play as they download) and for the smooth way it renders graphics. Flash files unlike animated but rasterized GIF and JPEG, are compact, efficient, and designed for optimized delivery.

Flash gives Web designers the ability to import artwork using whatever is bitmap or illustration tool they prefer, and to create animation and special effects, and add sound and interactivity. The content is then saved as file with a .SWF file name extension.

A frame is the standard unit of time measurement within Flash. Movies generally default to a frame rate of 12 frames per second. A key frame is a special kind of frame where the user defines how objects should look at that point in time. Flash then maintains that state of affairs until the next key frame, unless tweening is being applied. Tweening is the process of generating intermediate frames between two images to give the appearance that the first image evolves smoothly into the second image. Flash authoring environments allow a user to identify specific objects in an image and define how they should move and change during the tweening process, In the case of tweening being applied between key frames Flash ‘fills in’ the detail of the intermediate frames to create a smooth transition between the key frames.

Web users with Intel Pentium or Power Macintosh processors can download Flash Player to view Flash content, which works across multiple browsers and platforms.

To be able to create animation in a Flash authoring environment, for example the Flash 4 authoring environment, knowledge of the authoring environment is required. In particulars knowledge of the animation effects that can be applied to objects between key frames in required. Such knowledge has hitherto confined the creating of Flash animation to users intimately familiar with the Flash authoring environment.

### SUMMARY OF THE INVENTION

In one aspect, the invention provides a method for creating animation. The method comprises generating an exemplary animation file for each of a plurality of animation effects; associating at least one keyword with each exemplary animation file; receiving a search string from a user, the search string being indicative of an animation effect of interest performing a search to identify each animation effect for which there is a match between the search string and the at least one keyword associated with the animation effect; providing information about each animation effect identified in the search to the users receiving user-input to select an animation effect identified in the search; and responsive to the user-input to identify the animation effect binding the animation effect to a selected object.

Other aspects of the invention will be apparent from the detailed description below.

### BRIEF DESCRIPTION OF THE DRAWINGS

FIG. 1 shows a high-level block diagram of a processing system in accordance with one embodiment of the invention;

FIG. 2 shows a high-level block diagram of animation authoring software in accordance with one embodiment of the invention;

FIG. 3 shows a flowchart of a method for creating animation, in accordance with one embodiment of the invention;

FIG. 4 shows a flowchart of another method for creating animation, in accordance with one embodiment of the invention;

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the present invention disclose a method of creating animation, and a processing system that implements the method. While the method is generally applicable to any type of animation, for the purposes of this description the method will be described with reference to Flash animation. However, one skilled in that art would immediately realize that the techniques described herein are equally applicable to other types of animation.

In one embodiment, a user is allowed to search for a desired animation effect by inputting a search string into the system. For example, if the desired animation effect is rotation then the user may enter “rotate object” or a like phrase. In response to the input of the search string, a search is performed to identify the animation effects of interest based on the search string. Information on the identified animation effects is then provided to the user. The information may include a name and description for each of the animation effects. In one embodiment, an animation clip exemplary or representative of each animation is also provided to the user. Thus, the user can advantageously play a clip to determine whether a particular animation effect is to be used or not. Based on user-input, selected animation effects may be bound to objects. Objects may include geometric shapes, text objects, etc. Additionally the user is afforded creative control by being allowed to specify one or more control parameters that control application of the animation effect to the object during playback. For example, the control parameters may specify a duration for the animation effect or at what point during playback the animation effect is to commence. In one embodiment, a preview of the animation effects as applied to the object is provided and the user is allowed to change the animation effect or its control parameters. Once that user is satisfied, the system generates an animation file in a content delivery format such as the SWF format, wherein the animation effect(s) and the associated control parameters are bound to the object. The term bound to the object simply means that the animation effects, the control parameters, and the object (animation object) are so related in the animation file that during playback of the animation file, the object is rendered based on the animation effects and the associated control parameters.

Advantageously, the techniques disclosed herein allow a user having little or no knowledge of an animation authoring program such as Flash to create an animation with complex animation effects based on a keyword search. Other advantages of the present techniques will be apparent from the description below.

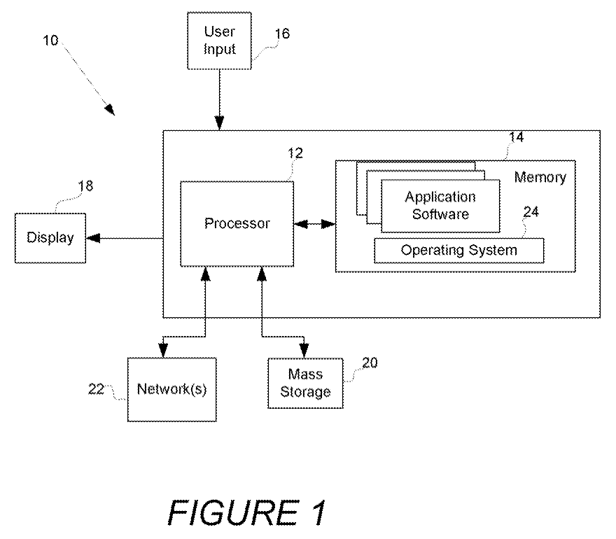

Turning now to FIG. 1 of the drawings there is shown a high-level block diagram of a processing system 10 in accordance with one embodiment of the invention. The processing system 10 typically includes at least one processor 12 coupled to a memory 14. The processor 12 may represent one or more processors (e.g., microprocessors), and the memory 14 may represent random access memory (RAM) devices comprising a main storage of the processing system 10, as well as any supplemental levels of memory e.g, cache memories, non-volatile or back-up memories (e.g. programmable or flash memories), read-only memories, etc. In addition, the memory 14 may be considered to include memory storage physically located elsewhere in the processing system 10, e.g. any cache memory in the processor 12 as well as any storage capacity used as a virtual memory, e.g., as stored on a mass storage device 20. The processing system 10 receives a number of inputs and outputs for communicating information externally. For interface with a user or operator, the processing system 10 may include one or more user input devices 16 (e.g., a keyboard, a mouse, etc.) and a display 18 (e.g., a Liquid Crystal Display (LCD) panel).

For additional storage, the processing system 10 may also include one or more mass storage devices 20, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the processing system 10 may include an interface with one or more networks 22 (e.g., a local area network (LAN), a wide area network (WAN), a wireless network, and/or the Internet among others) to permit the communication of information with other computers coupled to the networks. It should be appreciated that the processing system 10 typically includes suitable analog and/or digital interfaces between the processor 12 and each of the components 14, 16, 18 and 22 as is well known in the art.

The processing system 10 operates under the control of an operating system 24, and executes various computer software applications, components, programs objects, modules, etc. that will be described in greater detail below. Moreover, various applications, components, programs, objects, etc. may also execute on one or more processors in another computer coupled to the processing system 10 via a network 22, e.g. in a distributed computing environment, whereby the processing required to implement the functions of a computer program may be allocated to multiple computers over a network. In one embodiment, the processing system may be a client computer system. In another embodiment, the processing system 10 may be a server system that is coupled to a client computer system via a wide area network such as the Internet.

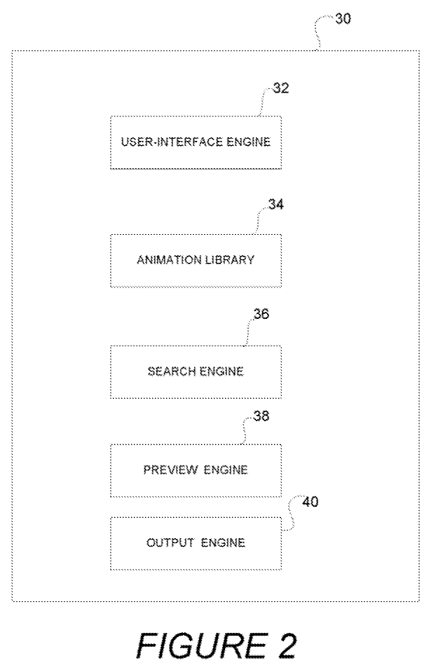

The memory 14 includes an animation authoring program 30 in accordance with one embodiment of the invention, the components of which can be seen in FIG. 2 of the drawings, The animation authoring software includes user-interface engine 32 which when executed by the processing system 10 generates a user-interface whereby a user can interact with the animation authoring software 32. In accordance with one embodiment of the invention, the user-interface may be a Graphical User-interface (GUI). The animation authoring software 30 also includes an animation library 34 which has a number of animation effects that a user can choose to be applied to an animation object. Examples of animation effects may include the following, in one embodiment, background change color, color change, fade, rotate, scale, slide off edge horizontal, slide off edge vertical, slide to edge horizontal, slide to edge vertical, slide to center (horizontal) slide to center (vertical), sine wave movement, square sine wave movement, triangle sine wave movement circular movement, spiral movement, spin rotation horizontal, spin rotation vertical, color to grey, color negatives, starfield snowing, rain, etc. Naturally in accordance with other embodiments, the animation library 34 may include additional or other animation effects. Each animation effect in the library 34 has information about the animation effect. The information may include a title or name for the animation effect, one or keywords descriptive of the animation effect, and a short animation file or clip that is exemplary for representative of the animation effect. The keywords are chosen so that a keyword search for an animation effect may be performed, as will be described below.

The animation authoring software 30 also includes a search engine 36. The search engine 36 implements a search algorithm to search for animation effects in the animation library 34. The search engine 36 takes a search string entered by a user via the user-interface and identifies matching animation effects from the library 34 based on a match of the user-input search string and the keywords associated with the clips in the library 34.

The matching animation effects identified by the search engine 36 forms a search result which is provided, for example displayed, to the user. In one embodiment the search result is displayed in such a manner that for each animation effect in the search result, the user can see the title of the animation effect, a description of the animation effect and “playback button” to activate playback of the animation. The significance of the playback button is that the user can select it to activate playback of the animation clip associated therewith, thus providing the user with a graphic illustration of the animation effect. The advantage of providing the user with an animation clip for each animation effect is that the user can play the clip to decide if the animation effect associated with the clip is desired or not. This feature is particularly useful in the case of a novice user who is not familiar with animation effects.

Having selected an animation effect using the search and playback operations describe above, the user is in a position to apply the animation effect to an object. In one embodiment, the user is allowed to generate or create an object via the user-interface. The point at which the object may be created may vary according to different embodiments. For example, in one embodiment, the object may be created after that animation effect to be applied to the object has been selected. In another embodiment, the object may be created before that animation effect is selected.

To apply a selected animation effect to an object, the user creates an association or link between the animation effect and the object using the mechanism of the user-interface. At this time, and optionally, the user can also specify one or more control parameters that are to control the application of the animation effect to the object. The control parameters may vary according to embodiments of the invention and may control the start/end frame (hence duration) of the animation effect, whether the animation effect is to be looped or repeated, the sequence in which the animation effect is to applied ( for example, a number of animation effects may execute serially, or in parallel, etc.).

Continuing with the components of the animation authoring software 30, it will be seen that the software 30 includes a preview engine 38. The preview engine 38 provides a mechanism for the user to preview a rendition of the animation object with the animation effect(s) applied to it. The point of the preview engine 38 is that a user can make changes to the animation effects and objects after previewing, but before creatiion of the final animation file.

For generation of the final animation file with all that animation effects bound to the animation objects, the animation authoring software 30 includes a file creation or output engine 40. The file creation engine 40 creates an animation file in a content delivery format such SWF wherein the animation effects and associated control parameters are bound to the animation objects.

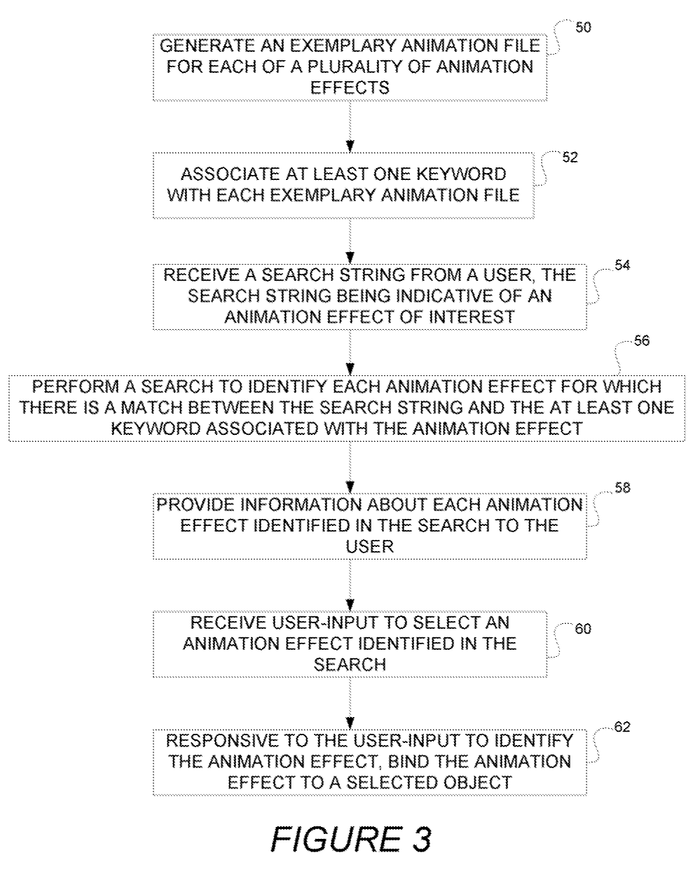

Having thus described the various components of the animation authoring software 30, it will be seen that the software may be used to perform the method for creating animation shown in the flowchart of FIG. 3 of the drawings. The method may be performed by a processing system such as the above-described processing system 10. Referring to FIG. 3, at block 50 an exemplary animation file for each of a plurality of animation effects is generated. The exemplary animation file comprises a short animation clip described above. At block 52, at least one keyword is associated with each exemplary animation file. At block 54, a search string from a user is received. The search string comprises keywords indicative of an animation effect of interest. The search string may be input via a keyboard of the processing system 10. In the case where the processing system is a server processing system coupled to a client processing system via an intermediate network, the search string is input via a keyboard of the client system and then transmitted to the server processing system via the intermediate network.

At block 56, the processing system 10 performs a search to identify each animation effect for which there is a match between the search string and the at least one keyword associated with the animation effect. At block 58, information about each animation effect identified in the search is provided as described above to the user. At block 60, user-input to select an animation effect identified in the search is received from the user. Depending on the embodiment of the processing system 10, a network may be required to perform block 60. At block 62, responsive to the user-input to identify the animation effect the animation effect is bound to a selected object in the manner described above.

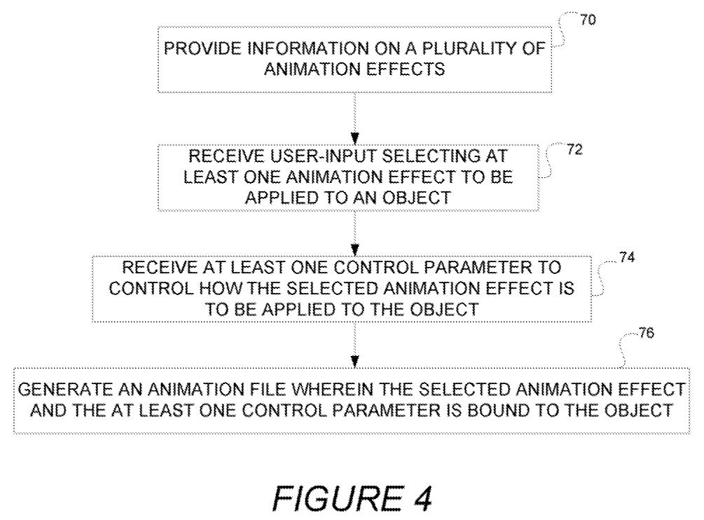

The animation authoring software 30 may also be used to perform the method for creating animation shown in the flowchart of FIG. 4 of the drawings The method may be performed by the processing system 10, and includes a block 70 in which information on a plurality of animation effects is provided to a user. The information may be provided pursuant to a search. Alternatively, the information may be provided when the user selects a particular library or folder of animation effects using the user-interface. At block 72, user-input selecting at least one animation effect to be applied to an object is received. At block 74, at least one control parameter to control how the selected animation effect is to be applied to the object is received from the user. At block 76, the processing system 10 generates an animation file wherein the selected animation effect and the at least one control parameter is bound to the object.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage TO devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

1. A method for creating animation, comprising:
generating an exemplary animation file for each of a plurality of animation effects;
associating at least one keyword with each exemplary animation file, receiving a search string from a user, the search string being indicative of an animation effect of interest;
performing a search to identify each animation effect for which there is a match between the search string and the at least one keyword associated with the animation effect;
providing information about each animation effect identified in the search to the user;
receiving user-input to select an animation effect identified in the search; and
responsive to the user-input to identify the animation effect, binding the animation effect to a selected object.

2. The method of claim 1 wherein providing the information about each animation effect comprises playing the exemplary animation file for the selected animation effect.

3. The method of claim 1; wherein binding the animation effect to the selected object comprises associating the selected animation effect with the selected object along with one or more control parameters to control how the selected animation effect is to be applied to the selected object during playback.

4. The method of claim 3, further comprising receiving user-input of the control parameters.

5. The method of claim 4, wherein the control parameters comprise a duration parameter that provides an indication of a duration for which the selected animation effect is to be applied to the selected object during playback.

6. The method of claim 4 wherein the control parameters comprise a sequence parameter that controls when in relation to other animation effects the selected animation effect is to be applied to the selected object during playback.

7. The method of claim 1 further comprising generating a preview wherein the selected animation effect is applied to the selected object.

8. A computer-readable medium having stored thereon a sequence of instructions which when executed on a processing system causes the processing system to perform a method comprising:
providing information on a plurality of animation effects;
receiving user-input selecting at least one animation effect to be applied to an object;
receiving at least one control parameter to control how the selected animation effect is to be applied to the object; and
generating an animation file wherein the selected animation effect and the at least one control parameter is bound to the object.

9. The computer-readable medium of claim 8, wherein providing the information on the plurality of animation effects comprises displaying a name associated with each animation effect.

10. The computer-readable medium of claim 8, wherein providing the information on the plurality of animation effects comprises displaying a description of each animation effect.

11. The computer-readable medium of claim 8, wherein providing information on the plurality of animation effects comprises playing an animation representative of an animation effect selected by a user.

12. The computer-readable medium of claim 8, wherein the plurality of animation effects is a selection of animation effects, the method then comprising generating the selection based on a keyword match of a user-input search string and predefined keywords associated with each animation effect.

13. The computer-readable medium of claim 8, wherein the plurality of animation effects are part of a library of animation effects selected based on user-input.

14. A processing system, comprising:
a processor; and
a memory coupled to the processor, the memory storing instructions corresponding to a search engine to allow a user to search for animation effects based on a search string; and a user-interface whereby the user can indicate that a particular animation effect identified as a result of a search is to be applied to an object, and whereby the user can specify one or more control parameters to control the application of the animation effect to the object,

15. The processing system of claim 14, wherein the user-interface displays information on each animation effect identified in the search.

16. The processing system of claim 14, wherein the information comprises a description associated with the animation effect.

17. The processing system of claim 16, wherein the information comprises an animation representative of the animation effect.

18. The processing system of claim 17, wherein the memory comprises instructions corresponding to file generation engine to generate an animation file with the animation effect and the control parameters bound to the object in content delivery format.

19. The processing system of claim 17, wherein the content delivery format is the SWF file format.

20. The processing system of claim 14, wherein the control parameters control a duration for the animation effect.
